(19) United States
(12) Patent Application Publication
(10) Pub. No.: US 2025/0028920 A1
(43) Pub. Date: Jan. 23, 2025

(54) PRINT DATA GENERATION DEVICE, PRINT DATA GENERATION METHOD, AND PROGRAM

(71) Applicant: Seiko Instruments Inc., Chiba-shi (JP)

(72) Inventors: Ryuichi OKA, Chiba-shi (JP); Naoto TSURUOKA, Chiba-shi (JP)

(21) Appl. No.: 18/781,184

(22) Filed: Jul. 23, 2024

(30) Foreign Application Priority Data
Jul. 23, 2023 (JP) 2023-122322

(51) Int. Cl. G06K 15/02

(52) U.S. Cl. CPC G06K 15/1859; G06K 15/1822

(57) ABSTRACT

A print data generation device includes: a print object data acquisition module configured to acquire print object data in which field information that is an object to be printed is expressed in a matrix by a first axis indicating a plurality of records that are objects to be printed and a second axis indicating columns of a plurality of classes of the objects to be printed; a printing position information acquisition module configured to acquire printing position information in which class information indicating classes of field information that correspond to the columns is associated with position information indicating printing positions that correspond to the classes of the columns; a generation module configured to generate, based on the printing position information, print data for printing the field information included in the print object data at the printing positions associated with the classes of the field information; and an output module configured to output the generated print data to a printing apparatus.

### RELATED APPLICATIONS

This application claims priority to Japanese Patent application No. JP 2023-122322 filed on Jul. 27, 2023, the entire content of which is incorporated herein by reference

### BACKGROUND OF THE INVENTION

### 1. Field of the Invention

The present disclosure relates to a print data generation device, a printing system, a print data generation method, and a program.

### 2. Description of the Related Art

There has been known a technology of printing a plurality of pieces of object data included in a record of a database on a label or other printing media (for example, Japanese Patent Application Laid-open No. 2015-227001). A printing system of the related art such as this takes a database including a plurality of records in from a host device, and prints, on a printing medium, information (object data) of fields which correspond to columns (items) included in each of the plurality of records of the database taken in. Specific examples of classes of object data include “product code,” “product name,” “price,” and “bar code.”

Generally speaking, a configuration of columns (items) of a database provided from a host device depends on settings of the host device. Accordingly, in a case in which the settings of the host device are changed and the configuration of the columns (items) of the database consequently changes, the printing system of the related art described above may require re-setting of print items, a printing position, and the like on the printing system side. A problem of this case is that laborious work is required of a user.

The present disclosure has been made in view of the above-mentioned circumstances, and it is an object of the present disclosure to provide a print data generation device, printing system, a print data generation method, and a program that are capable of reducing laboriousness of user's work regardless of a change in configuration of columns of a database.

### SUMMARY OF THE INVENTION

According to one embodiment of the present invention, there is provided a print data generation device including: a print object data acquisition module configured to acquire print object data in which field information that is an object to be printed is expressed in a matrix by a first axis indicating a plurality of records that are objects to be printed and a second axis indicating columns of a plurality of classes of the objects to be printed; a printing position information acquisition module configured to acquire printing position information in which class information indicating classes of field information that correspond to the columns is associated with position information indicating printing positions that correspond to the classes of the columns; a generation module configured to generate, based on the printing position information, print data for printing the field information included in the print object data at the printing positions associated with the classes of the field information; and an output module configured to output the generated print data to a printing apparatus.

In the above-mentioned print data generation device according to the one embodiment of the present invention, wherein the generation module is configured to generate, when the columns of the classes that are included in the printing position information are not included in the print object data, the print data with the printing positions that correspond to the columns of the excluded classes as blank fields in the printing position information.

In the above-mentioned print data generation device according to the one embodiment of the present invention, wherein, in the print object data, a record indicating the class information is placed as a head record.

In the above-mentioned print data generation device according to the one embodiment of the present invention, wherein the printing position information acquisition module is configured to acquire second printing position information in which column position information indicating positions of the columns that are aligned in a direction of the second axis is associated with position information indicating printing positions of field information that correspond to the columns, and wherein the generation module is configured to generate the print data based on association by one of the printing position information or the second printing position information.

In the above-mentioned print data generation device according to the one embodiment of the present invention, wherein the generation module is configured to generate the print data by determining, based on contents of a head record included in the print object data, which of the printing position information and the second printing position information is to be used for the association.

In the above-mentioned print data generation device according to the one embodiment of the present invention, wherein the generation module is configured to generate the print data by determining the classes of the columns of the field information to be printed at the printing positions, through one of forward matching or backward matching between the class information of the printing position information and information indicating the classes of the columns that are included in the print object data.

In the above-mentioned print data generation device according to the one embodiment of the present invention, wherein the generation module is configured to generate the print data by determining the classes of the columns of the field information to be printed at the printing positions, through exact matching between the class information of the printing position information and information indicating the classes of the columns that are included in the print object data.

According to one embodiment of the present invention, there is provided a printing system including: the print data generation device; and a printing apparatus configured to print based on the print data generated by the print data generation device.

According to one embodiment of the present invention, there is provided a print data generation method including: acquiring print object data in which field information that is an object to be printed is expressed in a matrix by a first axis indicating a plurality of records that are objects to be printed and a second axis indicating columns of a plurality of classes of the objects to be printed; acquiring printing position information in which class information indicating classes of field information that correspond to the columns is associated with position information indicating printing positions of field information that correspond to the columns; generating, based on the printing position information, print data for printing the field information included in the print object data at the printing positions associated with the classes of the field information; and outputting the generated print data to a printing apparatus. According to one embodiment of the present invention, there is provided a program for causing a computer to: acquire print object data in which field information that is an object to be printed is expressed in a matrix by a first axis indicating a plurality of records that are objects to be printed and a second axis indicating columns of a plurality of classes of the objects to be printed; acquire printing position information in which class information indicating classes of field information that correspond to the columns is associated with position information indicating printing positions of field information that correspond to the columns; generate, based on the printing position information, print data for printing the field information included in the print object data at the printing positions associated with the classes of the field information; and output the generated print data to a printing apparatus.

### BRIEF DESCRIPTION OF THE DRAWINGS

FIG. 1 is a diagram for illustrating an example of a function configuration of a printing system in at least one embodiment of the present disclosure.

FIG. 2 is a table for showing an example of product data in the at least one embodiment.

FIG. 3 is a diagram for illustrating an example of a flow of printing position information generation by a print data generation device according to the at least one embodiment.

FIG. 4 is a diagram for illustrating an example of a column selection image in the at least one embodiment.

FIG. 5 is a diagram for illustrating an example of selected column data in the at least one embodiment.

FIG. 6 is a diagram for illustrating an example of a print layout image in the at least one embodiment.

FIG. 7 is a table for showing an example of printing position information (a template) in the at least one embodiment.

FIG. 8 is a diagram for illustrating an example of a flow of print data generation in the at least one embodiment.

FIG. 9 is a table for showing an example of print object data in the at least one embodiment.

FIG. 10 is a diagram for illustrating an example of association between a column and a printing position by a class association method in the at least one embodiment.

FIG. 11 is a diagram for illustrating another example of association between a column and a printing position by the class association method in the at least one embodiment.

FIG. 12 is a diagram for illustrating an example of print data in the at least one embodiment.

FIG. 13 is a table for showing an example of print object data in a modification example of the at least one embodiment.

FIG. 14 is a diagram for illustrating an example of print data in the modification example in which the printing position is a blank field.

### DESCRIPTION OF THE EMBODIMENTS

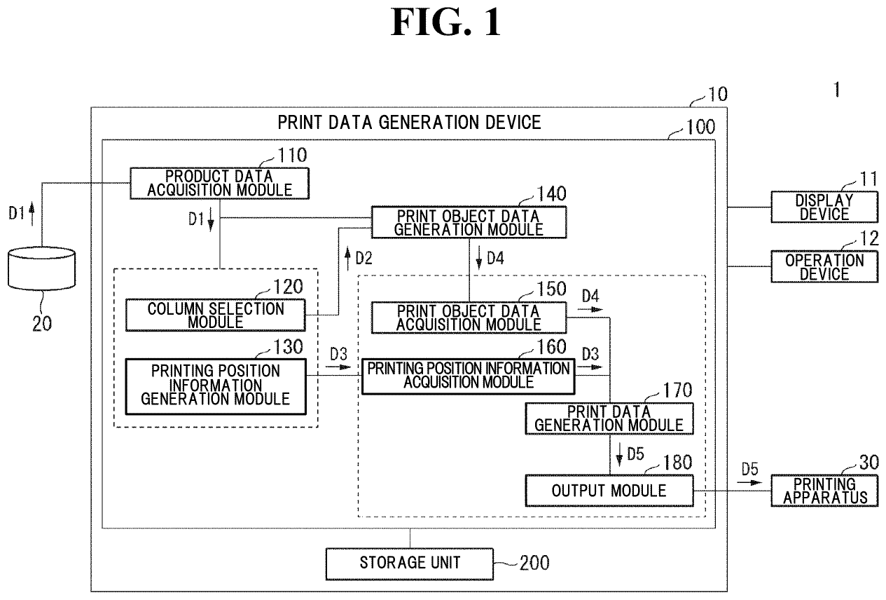

At least one embodiment of the present disclosure is described below with reference to the drawings. FIG. 1 is a diagram for illustrating an example of a function configuration of a printing system 1 in the at least one embodiment. The printing system 1 includes a print data generation device 10, a product database 20, and a printing apparatus 30.

The printing apparatus 30 is an apparatus for printing text and an image on a printing medium such as paper or films. An example of the printing apparatus 30 is a label printer. The printing apparatus 30 prints text and an image on a printing medium, based on print data D5 supplied from the print data generation device 10. The print data D5 is object data expressed in accordance with language specifications of the printing apparatus 30. In the case in which the printing apparatus 30 is a label printer, the print data D5 is, for example, image data including, as objects, a product code, a product name, a price, a bar code, and the like of a product to be printed. The print data D5 is generated based on product data D1.

The product data D1 is, for example, data output from a point-of-sale (POS) system or a product management system. Some POS systems and product management systems have a function of outputting the product data D1 for the purpose of backing up product data, utilizing product data on an external device, or the like. In an example of the at least one embodiment, the product data D1 is stored in the product database 20.

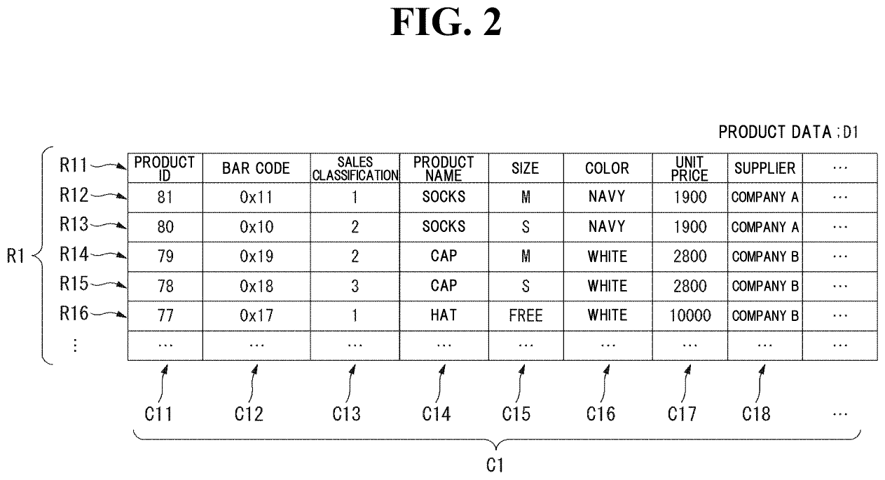

The product database 20 supplies the product data D1 to the print data generation device 10. An example of the product data D1 is described with reference to FIG. 2.

FIG. 2 is a table for showing an example of the product data D1 in the at least one embodiment. The product data D1 in the at least one embodiment is a file in a comma-delimited (or comma-separated value: CSV) format. In FIG. 2, the product data D1 is expressed as a matrix in which columns C are aligned in a column direction and records R are aligned in a row direction. An intersection between one of the columns C and one of the records R is called a field, and information stored in the field is also called field information. A file in the comma-delimited format can generally be expressed with pieces of field information of a plurality of classes discriminated from one another for each product. Being a file in a comma-delimited format, the product data D1 can express pieces of information on various attributes of a product (for example, product name, size, and price) in a manner that discriminates one from another. The product data D1 being a file in a comma-delimited format is an example. The product data D1 is only required to be in a file format capable of expressing pieces of field information of a plurality of classes for each product in a manner that discriminates field information of one class from field information of another class, and the file format is not limited to the comma-delimited format.

The columns C of the product data D1 indicate attributes of a product. Examples of attributes of a product include product ID_C11, bar code_C12, sales classification_C13, product name_C14, size_C15, color_C16, unit price_C17, and supplier_C18. In the following description, classes of attributes of a product that are indicated by the columns C are simply referred to as “classes of the columns C” in some places.

In the records R of the product data D1, pieces of field information of a plurality of products are sorted by product type. In the example shown in FIG. 2, a record R12 indicates “navy color socks in size M.”

In some cases, one of the plurality of records R that is at the head is designated to hold information indicating classes of the columns C. The information indicating classes of the columns C is information for distinguishing the class of one of the columns C from the class of another of the columns C. To give an example, when the class of one of the columns C is “product ID,” the information is a letter string of the “product ID,” an ASCII code of the letter string of the “product ID” (for example, 0x5546 0x54c1 0xff29 0xff24 in hexadecimal notation), or an identifier (for example, a numerical value such as “01”) associated with the “product ID” by a definition table (not shown) for identifying the classes of the columns C.

In the example of FIG. 2, a record R11 which is one of the records R that is at the head holds letter strings (product ID, bar code, sales classification, product name, size, color, unit price, supplier, and the like) indicating the classes of the columns C. Depending on the format of the product data D1, one of the records R that is designated to hold information indicating the classes of the columns C may be omitted, with the one of the records R that is at the head holding information of a product.

In the following description, “one of the records R that is a head record” refers to one of the records R of the product data D1 that is the first to hold valid field information, excluding the records R that hold invalid field information (for example, blank rows). For example, there is a case in which one of the records R of the product data D1 that is a first record is a blank row and one of the records R that is the first to hold valid field information is a second record. In this case, the one of the records R that is the second record is referred to as “one of the records R that is a head record” in some places. One of the records R that is the first to hold valid field information is referred to as “one of the records R that is a substantive head record” in some places. In other words, in the product data D1, one of the records R that is a substantive head record may hold letter strings indicating the classes of the columns C.

Depending on the format of the product data D1, the classes of the columns C may be arranged in an order different from an order shown in FIG. 2. For example, depending on the format of the product data D1, “product ID,” “product name,” . . . “bar code” may be arranged in the stated order, instead of an order in which “product ID” comes first, followed by “bar code,” “product name,” and others.

Referring back to FIG. 1, the print data generation device 10 is a so-called host device in the printing system 1. The print data generation device 10 includes a control unit 100 and a storage unit 200.

The storage unit 200 includes a semiconductor memory and a hard disk device, and stores a program and data that are used by the control unit 100. The control unit 100 has an arithmetic function implemented by a so-called central processing unit (CPU) or the like, and provides various functions based on the program and the data that are stored in the storage unit 200.

The print data generation device 10 is connected to, among others, a display device 11 such as a liquid crystal display and to an operation device 12 such as a mouse and a keyboard, and presents information to a user of the print data generation device 10 (hereinafter simply referred to as “user” in some places) as well as receiving the user's operation.

The print data generation device 10 generates the print data D5 based on the product data D1 supplied from the product database 20, and supplies the generated print data D5 to the printing apparatus 30. The print data generation device 10 generates the print data D5 by placing the field information of the product data D1 at a predetermined printing position, based on printing position information D3 (a so-called template) generated in advance. The print data generation device 10 according to the at least one embodiment also has a function of generating the printing position information D3 (template).

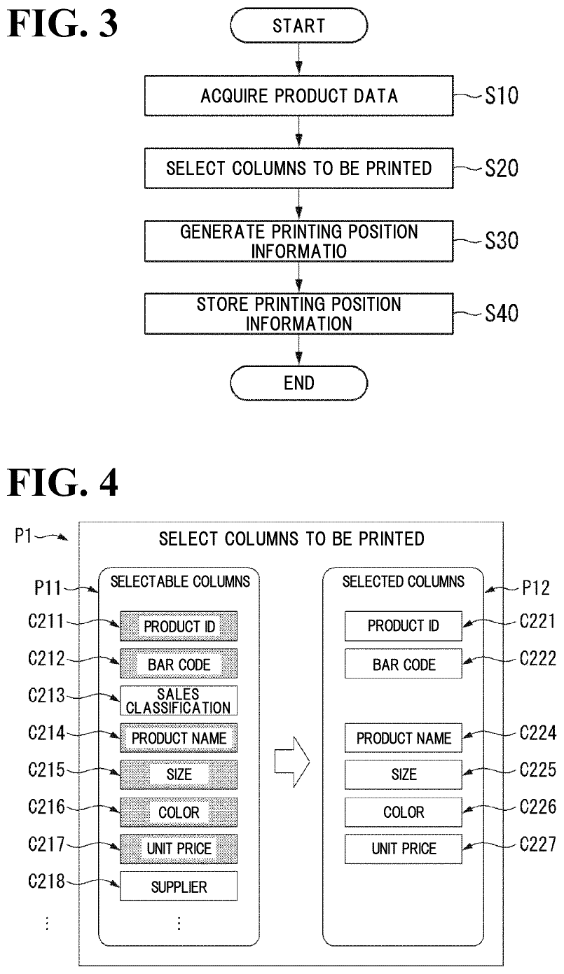

A specific example of a flow of operation executed by the print data generation device 10 to generate the printing position information D3 (template) is described below with reference to FIG. 1 and FIG. 3.

### Flow of Generation of Printing Position Information (Template)

FIG. 3 is a diagram for illustrating an example of a flow of generation of the printing position information D3 by the print data generation device 10 according to the at least one embodiment. The control unit 100 of the print data generation device 10 includes, as function modules thereof, a product data acquisition module 110, a column selection module 120, and a printing position information generation module 130.

(Step S10) The product data acquisition module 110 acquires the product data D1 from the product database 20. The product data acquisition module 110 supplies the acquired product data D1 to the column selection module 120.

(Step S20) The column selection module 120 selects some of the columns C that are objects to be printed, based on the user's operation.

FIG. 4 is a diagram for illustrating an example of a column selection image P1 in the at least one embodiment. The column selection module 120 causes the display device 11 to display the column selection image P1. The column selection image P1 is an image for enabling the user to select, out of the columns C of a plurality of classes included in the product data D1, the columns C to be printed on a printing medium. The column selection image P1 includes a selectable column image P11 and a selected column image P12.

The product data D1 includes information to be presented to customers of the product (for example, information to be printed on a product label) and information that is not presented to the customers (for example, information for internal management). In the example illustrated in FIG. 4, “product ID,” “bar code,” “product name,” “size,” “color,” and “unit price” are each the information to be presented to the customers, and “sales classification” and “supplier” are each the information for internal management that is not to be presented to the customers.

The column selection image PI is an image for enabling the user to select the columns C of the classes to be presented to the customers of the product, out of the classes of the columns C of the product data D1. The user selects the columns C to be printed out of the selectable columns C displayed in the selectable column image P11. In the example illustrated in FIG. 4, product ID_C221, bar code_C222, product name_C224, size_C225, color_C226, and unit price_C227 are selected as the column C to be printed. The columns C to be printed are displayed in the selected column image P12. That is, the columns C that are displayed in the selected column image P12 are the columns C that are selected as the columns C to be printed.

In the selectable column image P11, the selected columns C (for example, product ID_C221, bar code_C222, product name_C224, size_C225, color_C226, and unit price_C227) are displayed in a mode different from a display mode of the columns C that are not selected as objects to be printed (for example, sales classification_C213 and supplier_C218). Displaying in this manner enables the printing system 1 to present which columns C are selected as objects to be printed to the user in an easily understood way. The display mode illustrated in FIG. 4 is an example, and, in another example, the selected columns C may not be displayed in the selectable column image P11.

When the user performs operation of confirming a result of selecting the columns C, the column selection module 120 generates selected column data D2 based on the selected columns C (that is, the columns C that are displayed in the selected column image P12). In the following description, the columns C that have been selected are referred to as “selected columns C2” in some places.

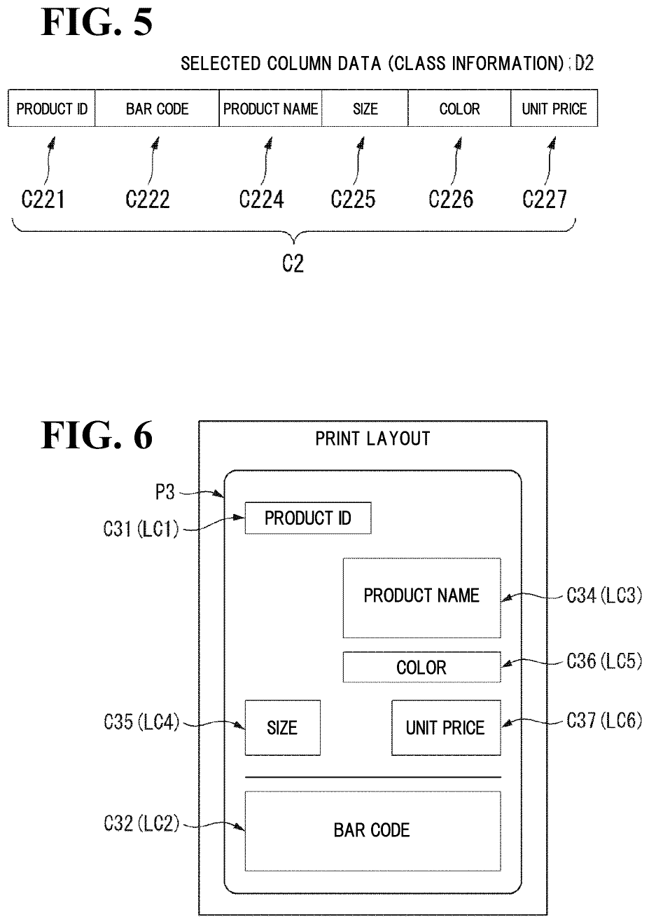

FIG. 5 is a diagram for illustrating an example of the selected column data D2 in the at least one embodiment. The selected column data D2 (class information) is information indicating classes of pieces of field information that correspond to the columns C selected as objects to be printed. In the example illustrated in FIG. 5, product ID_C221, bar code_C222, product name_C224, size_C225, color_C226, and unit price_C227 are defined in the selected column data D2 as classes of pieces of field information that correspond to the selected columns C2. The column selection module 120 stores the generated selected column data D2 in the storage unit 200.

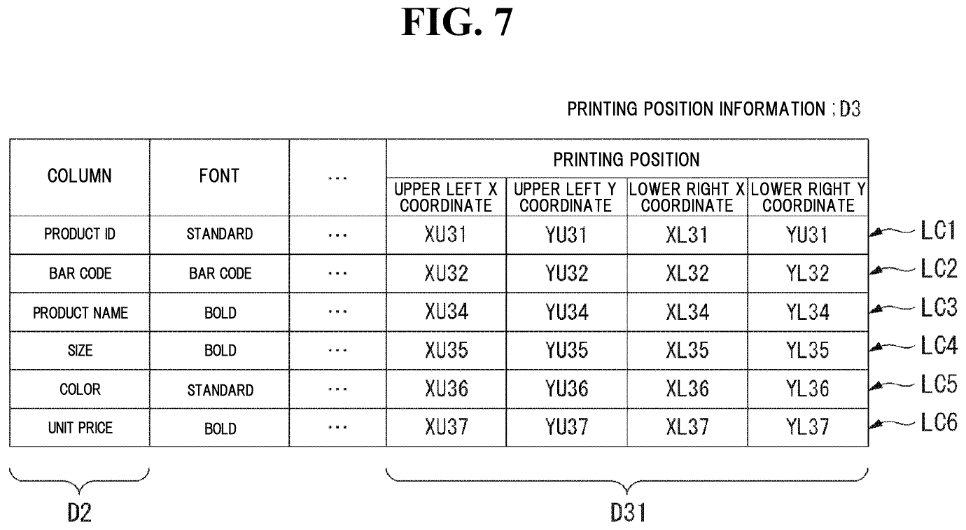

(Step S30) Referring back to FIG. 3, the printing position information generation module 130 generates the printing position information D3. Description is given on the printing position information D3 with reference to FIG. 6 and FIG. 7.

FIG. 6 is a diagram for illustrating an example of a print layout image P3 in the at least one embodiment. The print layout image P3 is an image for enabling the user to edit a position, a size, a font, and the like of information to be printed on a printing medium. The user manipulates images displayed in the print layout image P3 to define the position, the size, the font, and the like of the information to be printed on a printing medium. The printing position information D3 is information indicating the position, the size, the font, and the like that have been edited with use of the print layout image P3. That is, the printing position information D3 is a template for defining the position, the size, the font to be used, and the like of the information to be printed on a printing medium.

Images of columns C31, C32, C34, C35, C36, and C37 included in the print layout image P3 correspond to product ID_C221, bar code_C222, product name_C224, size_C225, color_C226, and unit price_C227 included in the selected column data D2, respectively. That is, the printing position information generation module 130 presents the print layout image P3 to the user, based on the selected column data D2 stored in Step S20. The user edits printing positions, sizes, fonts, and the like of the columns C31, C32, C34, C35, C36, and C37 of the print layout image P3. In the example illustrated in FIG. 6, “product ID,” “bar code,” “product name,” “size,” “color,” and “unit price” are placed at a printing position LC1, a printing position LC2, a printing position LC3, a printing position LC4, a printing position LC5, and a printing position LC6, respectively. When the user confirms the edit, the printing position information generation module 130 generates the printing position information D3 (template).

FIG. 7 is a table for showing an example of the printing position information D3 (template) in the at least one embodiment. In the printing position information D3, a name of each one of the columns C indicated by the selected column data D2 (class information) is associated with position information D31 indicating a position at which the field information of the column C is to be printed.

To give an example, “product ID” is associated with the printing position LC1 and “bar code” is associated with the printing position LC2. The printing position LC1 is a rectangular range identified by upper left coordinates (XU31, YU31)-lower right coordinates (XL31, YL31) indicated by position information D31. The format of the selected column data D2 shown in FIG. 7 is an example, and the selected column data D2 can have any format that functions as a printing template without being limited thereto. For example, the format that specifies the printing position by a rectangular range is an example, and the printing position may be defined by another format.

(Step S40) Referring back to FIG. 3, the printing position information generation module 130 stores the generated printing position information D3 in the storage unit 200.

Through the steps described above, the printing system 1 generates the printing position information D3 from the product data D1. The printing system 1 thus has a function of editing the template based on the product data D1. That is, the printing system 1 uses the columns C included in the product data D1 to present choices of the classes of the columns C to be printed and the print layout image P3 to the user. According to the thus configured printing system 1, the user's trouble of creating a template can be reduced compared to a case in which the user creates a template by inputting items to be printed.

### Flow of Generation of Print Data

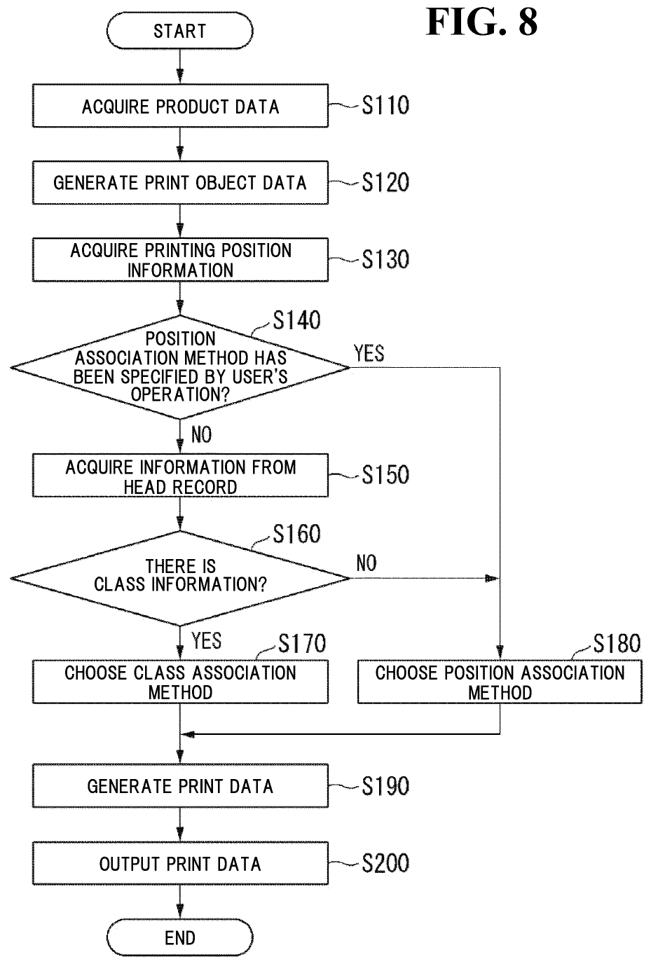

A flow of generating the print data D5 is described next with reference to FIG. 8.

FIG. 8 is a diagram for illustrating an example of a flow of generating the print data D5 in the at least one embodiment. The print data generation device 10 generates the print data D5 from the product data D1 based on the template generated through Step S10 to Step S40 described above, or a template generated by another device.

In this example, description is given on processing executed in a case in which the print data generation device 10 generates data (print object data D4) by extracting the columns C of the classes to be printed based on the product data D11 acquired from the product database 20, and then generates the print data D5 from the print object data D4. In some situations, the print object data D4 may be generated in advance.

In the description given below, processing of generating the print object data D4 is Step S110 to Step S120. That is, in a case in which the print data generation device 10 generates the print object data D4, the processing starts from Step S110. In a case in which the print object data D4 is generated in advance, the processing steps of Step S110 and Step S120 are omitted, and the processing starts from S130.

(Step S110) A print object data generation module 140 acquires the product data D1 from the product data acquisition module 110 and acquires the printing position information D3 from the storage unit 200.

(Step S120) The print object data generation module 140 generates the print object data D4. As described above, the printing position information D3 (a template) includes information for identifying the classes of the columns C to be printed (i.e., the selected column data D2), out of the plurality of classes of the columns C included in the product data D1. The print object data generation module 140 selects the columns C of the classes defined in the selected column data D2, out of the columns C of the plurality of classes included in the product data D1.

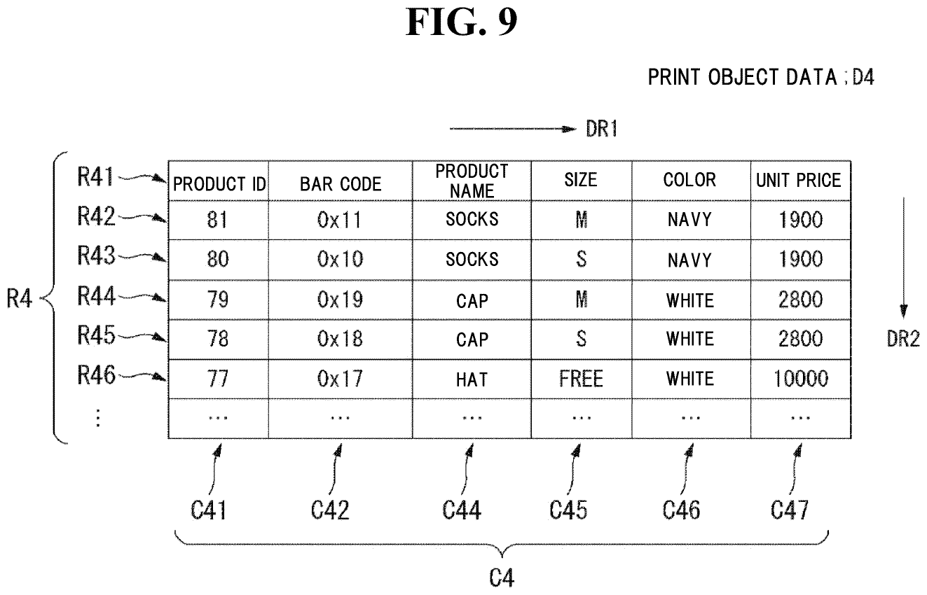

More specifically, as described above, the product data D1 includes, as the classes of the columns C, product ID_C11, bar code_C12, sales classification_C13, product name_C14, size_C15, color_C16, unit price_C17, and supplier_C18. In the selected column data D2, product ID_C221, bar code_C222, product name_C224, size_C225, color_C226, and unit price_C227 are defined as the classes of the selected columns C2. Out of the columns C of the plurality of classes included in the product data D1, the print object data generation module 140 determines the product ID, the bar code, the product name, the size, the color, and the unit price which are defined in the selected column data D2 as the columns C of the classes to be included in the print object data D4, and generates the print object data D4. An example of the print object data D4 generated by the print object data generation module 140 is shown in FIG. 9.

FIG. 9 is a table for showing an example of the print object data D4 in the at least one embodiment. The print object data D4 in the at least one embodiment is, similarly to the product data D1, a file in a so-called comma-delimited format. The print object data D4 in the at least one embodiment is data in which pieces of field information to be printed are expressed in a matrix by a first direction DR1 (a first axis) indicating the plurality of records R to be printed and a second direction DR2 (a second axis) indicating the columns C of a plurality of classes to be printed. The first axis represents one of a row and a column, and the second axis means an axis different from the first axis out of the row and the column. That is, the records R and the columns C may each be arranged in any of the row direction and the column direction. For example, the records R may be arranged in the column direction, whereas the columns C are arranged in the row direction.

As described above, one of the records R of the product data D1 that is a head record holds information indicating the classes of the columns C (for example, letter strings such as “product ID,” “bar code,” “sales classification,” “product name,” “size,” “color,” “unit price,” and “supplier”) in some cases. In the case in which one of the records R of the product data D1 that is a head record holds information indicating the classes of the columns C, the print object data generation module 140 generates the print object data D4 by including the information indicating the classes of the columns C in one of the records R of the print object data D4 that is a head record. In other words, in the case in which one of the records R of the product data D1 that is a head record holds information indicating the classes of the columns C, the print object data D4 that includes the information indicating the classes of the columns C in one of the records R that is a head record is generated.

(Step S130) Referring back to FIG. 8, a print object data acquisition module 150 acquires the print object data D4 generated by the processing described above (or the print object data D4 generated in advance). In Step S130, a printing position information acquisition module 160 acquires the printing position information D3 (a template) from the storage unit 200 as well. As described above, the printing position information D3 (a template) is information that associates the selected column data D2 (class information) indicating classes of the field information that correspond to the columns C and the position information D31 indicating printing positions that correspond to the classes of the selected columns C.

That is, the printing position information acquisition module 160 acquires the printing position information D3 which associates the selected column data D2 (class information) indicating the classes of field information that correspond to the columns C and the position information D31 indicating printing positions that correspond to the classes of the selected columns C.

### Types of Templates

The control unit 100 has a function of selecting, from a plurality of types of templates, a template to be used in generation of the print data D5. An example of types of templates selectable by the control unit 100 is described.

### (1) Column Position Association Template

A column position association template is a template of a type that associates positions of the columns C included in the print object data D4 with printing positions of the print data D5. The positions of the columns C are indicated by numbers of the columns C aligned in order in the first direction DR1 of the print object data D4. For example, in the case of the example of the print object data D4 shown in FIG. 9, the column for the product ID is at a first position, the column for the bar code is at a second position, and so on. The thus defined column position association template associates the positions of the columns C with printing positions, and accordingly simplifies specification of the columns C in the generation of the print data D5. On the other hand, when arrangement of the columns C of the print object data D4 changes, the position association template requires to be edited in order to match the positions of the columns C in the print data D5 to the change in arrangement of the print object data D4. In short, the column position association template has an advantage of being simple in configuration but has a problem in that a change in arrangement of the columns C of the print object data D4 necessitates editing of the template and accordingly renders the user's work laborious. In the following description, the column position association template is referred to as “second printing position information D3-2 (second template)” in some places.

### (2) Column Class Association Template

A column class association template is a template of a type that associates the classes of the columns C included in the print object data D4 with printing positions of the print data D5. The classes of the columns C are indicated by information that indicates the classes of the columns C included in the print object data D4. For example, in the case of the example of the print object data D4 shown in FIG. 9, the product ID is a first class, the bar code is a second class, and so on. The thus defined column class association template associates the information indicating the classes of the columns C with the printing positions and, accordingly, even when the arrangement of the columns C of the print object data D4 changes, enables matching of the positions of the columns C in the print data D5 to the change in arrangement of the print object data D4, without requiring to be edited.

When generating the print object data D4, the print data generation device 10 can choose which of the “column position association template” and the “column class association template” described above to refer to. A method of generating the print object data D4 with reference to the “column position association template” is referred to as “position association method” in some places. A method of generating the print object data D4 with reference to the “column class association template” is referred to as “class association method” in some places.

In the description given above, the column class association template is referred to as “printing position information D3.” In the following description, when the column class association template and the column position association template are to be distinguished from each other, the column class association template is referred to as “first printing position information D3-1” in some places. When the column class association template and the column position association template are not distinguished from each other, those templates may collectively be referred to as “printing position information D3” in some places. In short, there are a case in which the printing position information D3 is a collective term for the column class association template and the column position association template, and a case in which the printing position information D3 means the column class association template.

That is, a print data generation module 170 acquires one of (or both of) the printing position information D3 (in this case, the first printing position information D3-1; the first template) or the second printing position information D3-2 (the second template). The print data generation module 170 generates the print data D5 based on association by one of the first printing position information D3-1 or the second printing position information D3-2.

The print data generation device 10 chooses a template type (that is, one of the position association method or the class association method) by means of the user's operation or by means of automatic determination of the print data generation device 10.

(Step S140) The print data generation module 170 determines whether the position association method has been specified by the user's operation. When it is determined by the print data generation module 170 that the position association method has been chosen, the process proceeds to Step S180. When it is determined by the print data generation module 170 that the position association method has not been chosen (for example, when it is determined that the class association method has been employed or none of the methods has been chosen), the process proceeds to Step S150.

(Step S150) The print data generation module 170 acquires pieces of field information of the respective columns C from one of the records R of the print object data D4 that is a head record. As described above, one of the records R of the print object data D4 that is a head record holds information indicating the classes of the columns C (for example, letter strings such as “product ID,” “bar code,” “sales classification,” “product name,” “size,” “color,” “unit price,” and “supplier”) in some cases.

(Step S160) The print data generation module 170 determines whether one of the records R of the print object data D4 that is a head record holds information indicating the classes of the columns C. Various methods are employable to determine whether one of the records R of the print object data D4 that is a head record holds information indicating the classes of the columns C. For example, a method that compares the one of the records R of the print object data D4 that is a head record and the selected column data D2 (the class information; see FIG. 5) may be used.

In the case of this method, the print data generation module 170 compares letter strings held in the respective fields of the one of the records R that is a head record to letter strings included in the selected column data D2 (the class information). When letter strings held in any of the fields of the one of the records R that is a head record match letter strings included in the selected column data D2, the print data generation module 170 determines that the one of the records R of the print object data D4 that is a head record holds information indicating the classes of the columns C.

In other words, in a case in which one of the records R that indicate the selected column data D2 (the class information) is placed as the one of the records R of the print object data D4 that is a head record, letter strings held in some of the fields of the one of the records R that is a head record may match letter strings included in the selected column data D2. In this case, the print data generation module 170 determines that the one of the records R of the print object data D4 that is a head record holds information indicating the classes of the columns C.

The print data generation module 170 may compare letter strings held in the respective fields of the one of the records R that is a head record and letter strings included in the selected column data D2 (the class information) by so-called “forward matching” or “backward matching.” That is, the print data generation module 170 may use forward matching or backward matching between the selected column data D2 (the class information) of the first printing position information D3-1 and information indicating the classes of the columns C that is included in the print object data D4 to determine the classes of the columns C of the field information to be printed at printing positions.

Among pieces of information indicating the classes of the columns C, there may be sets of letter strings that have substantially the same meaning but vary in notation, such as “product name” and “product appellation.” In the case of this example, comparison by forward matching (for example, “product name *.” The symbol “*” represents any letter.) enables the print data generation module 170 to appropriately determine, regardless of the notation variations, that both include information indicating one of the classes of the columns C.

The print data generation module 170 may also compare letter strings held in the respective fields of the one of the records R that is a head record and letter strings included in the selected column data D2 (the class information) by so-called “exact matching.” That is, the print data generation module 170 may use exact matching between the selected column data D2 (the class information) of the first printing position information D3-1 and information indicating the classes of the columns C that is included in the print object data D4 to determine the classes of the columns C of the field information to be printed at printing positions.

Among pieces of information indicating the classes of the columns C, there may be similar expressions that mean substantially different attributes, such as “product name” and “product ID.” In the case of this example, comparison by exact matching enables the print data generation module 170 to discriminate “product name” and “product ID” from each other, and make appropriate determination.

In the description given above, the print data generation module 170 determines whether one of the records R of the print object data D4 that is a head record holds information indicating the classes of the columns C by utilizing letter strings included in the selected column data D2 (the class information), but the present disclosure is not limited thereto.

### MODIFICATION EXAMPLE 1

The print data generation module 170 may determine that the one of the records R of the print object data D4 that is a head record holds information indicating the classes of the columns C when information of the respective fields of the one of the records R that is a head record has a format different from a format of the other records R. To give an example, the print data generation module 170 determines that the one of the records R that is a head record holds information indicating the classes of the columns C when fields of the records R other than the one of the records R that is a head record have a numerical format, and the one of the records R that is a head record holds letter strings.

### MODIFICATION EXAMPLE 2

The print data generation module 170 may learn, in advance, (for example, by machine learning) general item names used in product data to determine that the one of the records R that is a head record holds information indicating the classes of the columns C when information of the respective fields of the one of the records R that is a head record includes the learned general item names.

### MODIFICATION EXAMPLE 3

The print data generation module 170 may learn, in advance, (for example, by machine learning) meaning of general item names used in product data to determine that the one of the records R that is a head record holds information indicating the classes of the columns C when item names of the respective fields of the one of the records R that is a head record include the item names which have the same meaning as the meaning of the learned items.

Referring back to FIG. 8, when it is determined by the print data generation module 170 that the one of the records R of the print object data D4 that is a head record holds information indicating the classes of the columns C, the process proceeds to Step S170. When it is determined by the print data generation module 170 that the one of the records R of the print object data D4 that is a head record holds no information indicating the classes of the columns C, the process proceeds to Step S180.

In other words, the print data generation module 170 determines which of the first printing position information D3-1 and the second printing position information D3-2 is to be used for association, based on whether the one of the records R of the print object data D4 that is a head record is one of the records R that indicates the classes of the columns C shown in the selected column data D2 (the class information). That is, the print data generation module 170 determines which of the first printing position information D3-1 and the second printing position information D3-2 is to be used for association, based on contents of the one of the records R of the print object data D4 that is a head record.

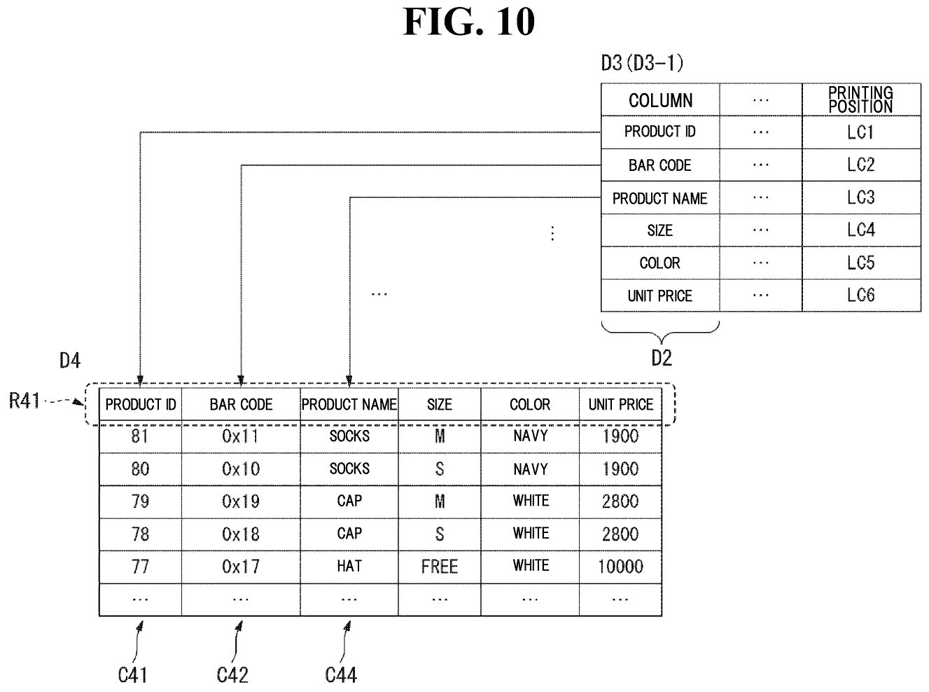

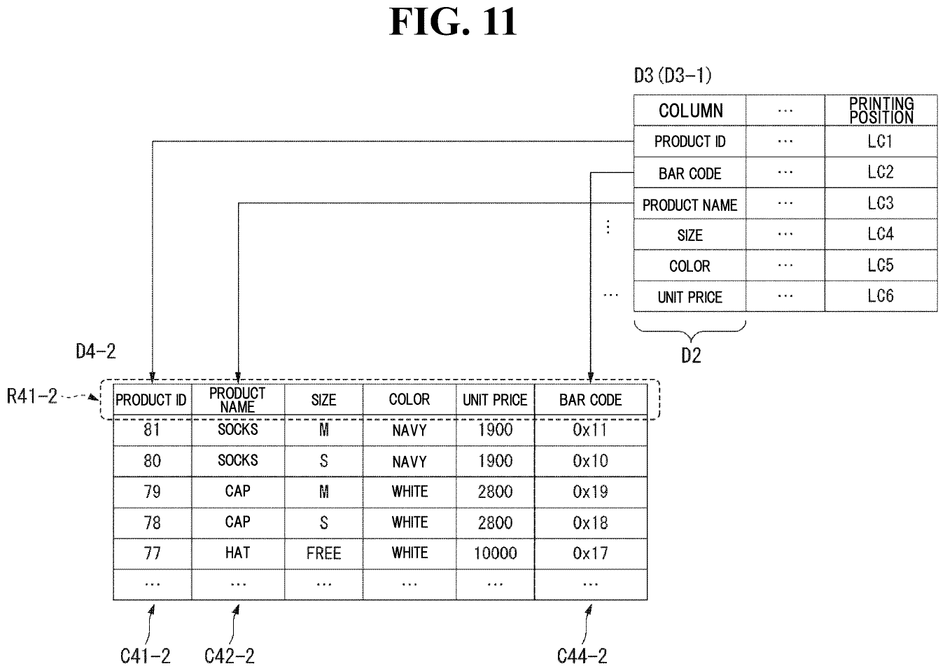

(Step S170) The print data generation module 170 chooses a method that refers to the first printing position information D3-1 (that is, the class association method), out of the printing position information D3. An example of association between the columns C and printing positions by the class association method is described with reference to FIG. 10 and FIG. 11.

FIG. 10 is a diagram for illustrating an example of association between the columns C and printing positions by the class association method in the at least one embodiment. The print data generation module 170 compares letter strings of the selected column data D2 of the first printing position information D3-1 and letter strings of a head record R41 of the print object data D4. In the example of FIG. 10, “product ID” of a column C41 of the print object data D4 and “product ID” of the first printing position information D3-1 match. In this case, the print data generation module 170 associates the columns C41 of the print object data D4 with the printing position LC1. Similarly, the print data generation module 170 associates a column C42 of the print object data D4 which holds “bar code” with the printing position LC2, and associates a column C44 of the print object data D4 which holds “product name” with the printing position LC3.

FIG. 11 is a diagram for illustrating another example of association between the columns C and printing positions by the class association method in the at least one embodiment. In the case of this example, arrangement of the columns C of print object data D4-2 differs from that of the print object data D4 illustrated in FIG. 10. Specifically, “bar code” is placed between “product ID” and “product name” in the print object data D4. In the print object data D4-2, “bar code” is placed after “unit price.” As in the case illustrated in FIG. 10, the print data generation module 170 compares letter strings of the selected column data D2 of the first printing position information D3-1 and letter strings of a head record R41-2 of the print object data D4. In the example of FIG. 11, “product ID” of a column C41-2 of the print object data D4-2 and “product ID” of the first printing position information D3-1 match. In this case, the print data generation module 170 associates the column C41-2 of the print object data D4 with the printing position LC1. Similarly, the print data generation module 170 associates a column C44-2 of the print object data D4 which holds “bar code” with the printing position LC2, and associates a column C42-2 of the print object data D4 which holds “product name” with the printing position LC3.

As described above, the arrangement of the columns C of the product data D1 is sometimes changed in various manners due to settings of a host system that generates the product data D1, or for other reasons. The arrangement of the columns C of the print object data D4 depends on the arrangement of the columns C of the product data D1 and, accordingly, variations in arrangement of the columns C of the product data D1 may cause the arrangement of the columns C of the print object data D4 to vary as well. The printing system 1 in the at least one embodiment uses the column class association template as the printing position information D3 (a template) to associate the columns C with the printing positions LC. Accordingly, with the printing system 1 in the at least one embodiment, the columns C and the printing positions LC can be associated with each other without editing the template even when the arrangement of the columns C of the print object data D4 is caused to vary. That is, the printing system 1 in the at least one embodiment can eliminate template editing for dealing with a change in arrangement of the columns C of the print object data D4, and can accordingly reduce the laboriousness of the user's work.

(Step S180) Referring back to FIG. 8, the print data generation module 170 chooses a method that refers to the second printing position information D3-2 (that is, the position association method), out of the printing position information D3. According to the thus configured printing system 1, the columns C and the printing positions LC can be associated with each other even when information indicating the classes of the columns C cannot be extracted from the print object data D4.

(Step S190) Referring back to FIG. 8, the print data generation module 170 associates field information included in the print object data D4 with a printing position associated with the class of the field information, based on the printing position information D3, to thereby generate the print data D5. The print data D5 is information (for example, image data) for causing the printing apparatus 30 to print field information included in the print object data D4.

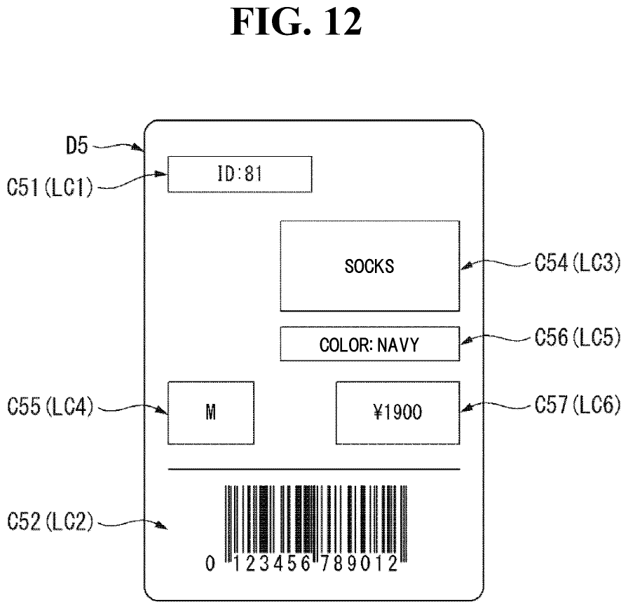

FIG. 12 is a diagram for illustrating an example of the print data D5 in the at least one embodiment. The print data generation module 170 generates the print data D5 by inserting information of each one of the records R of the print object data D4 to a layout (at the printing positions LC) set with use of the print layout image P3 (see FIG. 6) described above. In the example illustrated in FIG. 12, field information of a second record R42 of the print object data D4 shown in FIG. 9 is inserted.

For a third record R43 and subsequent records R as well, the print data generation module 170 inserts field information included in the records R at the printing positions LC set with the use of the template, to thereby sequentially generate the print data D5.

In the case in which one of the records R of the print object data D4 that is a head record (for example, the first record R41 of FIG. 9) is a record R indicating item names of the columns C, the print data generation module 170 may generate the print data D5 of the one of the records R that is a head record. According to the thus configured printing system 1, the print data D5 with which the item names are printed can be generated, and a check work for checking whether the user has properly set a print layout can accordingly be facilitated.

(Step S200) Referring back to FIG. 8, an output module 180 outputs the print data D5 generated by the print data generation module 170 to the printing apparatus 30. As a result, a printing medium on which contents reflecting the print data D5 are printed is output from the printing apparatus 30.

### MODIFICATION EXAMPLE

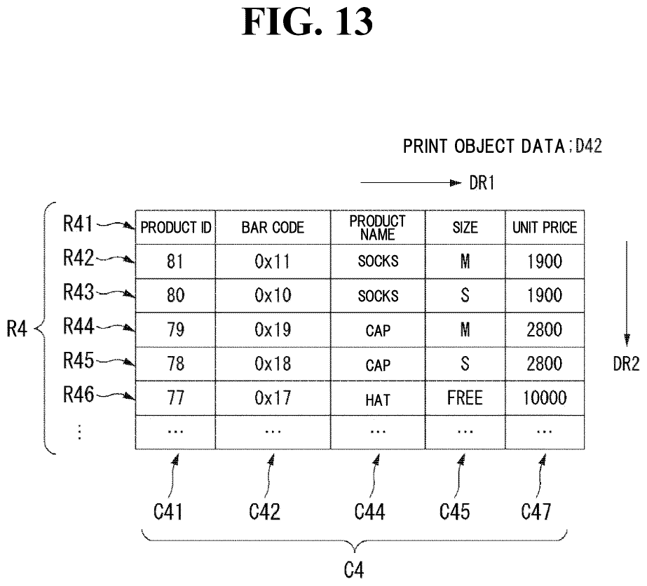

FIG. 13 is a table for showing an example of print object data D42 in a modification example of the at least one embodiment. In this modification example, the print object data D42 does not include one of the columns C that is included in the print object data D4 as a column for “color.”

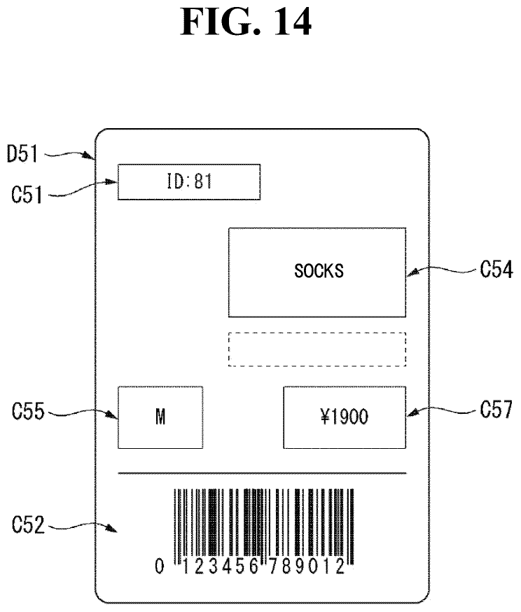

In a case in which one of the columns C of a class included in the printing position information D3 (the first printing position information D3-1) is not included in the print object data D4, the print data generation module 170 generates the print data D5, with a printing position associated with the one of the columns C of the class as a blank field in the printing position information D3. An example of print data D51 in which the printing position is a blank field is illustrated in FIG. 14.

FIG. 14 is a diagram for illustrating an example of the print data D51 in this modification example in which the printing position is a blank field. In the example of FIG. 14, the printing position LC5 for “color” included in the print data D5 of FIG. 12 described above is a blank field.

As described above, the arrangement of the columns C of the product data D1 is sometimes changed in various manners due to settings of a host system that generates the product data D1, or for other reasons. The various changes in arrangement of the columns C may include an addition or a removal of items of the columns C (missing of an item). Missing of an item here means that one of the columns C of a class set as an object to be printed in the printing position information D3 (a template) is not included in the product data D1. For example, in the case of the modification example described above, the product data D1 in which the item “color” is missing is provided. The arrangement of the columns C of the print object data D4 depends on the arrangement of the columns C of the product data D1, and missing of the item of one of the columns C of the product data D1 accordingly causes missing of the item in the columns C of the print object data D4 as well. The printing system 1 in the at least one embodiment uses the column class association template as the printing position information D3 (a template) to associate the columns C and the printing positions LC with each other. When executing the association, in a case in which one of the columns C of a class defined in the template is found out to be not included in the print object data D4, the printing system 1 generates the print data D5 with the class as a blank field, without waiting for the template to be edited.

“Setting a printing position associated with the one of the columns C of the class as a blank field” described above can be paraphrased as not linking the product data D1 and the print object data D4 (that is, ignoring information about the one of the columns C of the class defined in the printing position information D3). That is, in the case in which one of the columns C of a class defined in the template is not included in the print object data D4, the printing system 1 in the at least one embodiment generates the print data D5 without linking (by ignoring) the one of the columns C of the class. Accordingly, in a case in which the product data D1 and the print object data D4 are not completely linked, the printing system 1 in the at least one embodiment is capable of generating the print data D5 free of inconsistency in terms of association between the columns C and the printing positions LC without editing the template.

As described above, the printing system 1 in the at least one embodiment can eliminate template editing for dealing with a change in arrangement of the columns C of the print object data D4, and can accordingly reduce the laboriousness of the user's work.

A program for implementing the function of any component of any device described above may be recorded in a computer-readable recording medium so that the program is read by a computer system to be executed. The “computer system” here includes an operating system or hardware including peripheral devices. Further, the “computer-readable recording medium” is a portable medium such as a flexible disk, a magneto-optical disk, a ROM, or a compact disc read-only memory (CD-ROM), or a storage device built in the computer system, such as a hard disk drive. The term “computer-readable recording medium” also includes a medium which holds a program for a fixed period of time, for example, a volatile memory included in a computer system serving as a server or a client in a case in which a program is transmitted via a network such as the Internet, or a communication line such as a telephone line. The volatile memory may be, for example, a random access memory (RAM). The recording medium may be, for example, a non-transitory recording medium.

The above-mentioned program may be transmitted from the computer system in which the program is stored in, for example, the storage device, to another computer system via a transmission medium or through a transmission wave in a transmission medium. The “transmission medium” here through which a program is transmitted refers to a medium having a function of transmitting information, for example, a network such as the Internet or a communication line such as a telephone line.

Further, the above-mentioned program may be intended to implement some of the functions described above. Further, the above-mentioned program may be a program which enables the functions described above to be implemented when being combined with a program that is already recorded in the computer system, which is what is called “differential file.” The differential file may also be referred to as “differential program.”

The function of any component of any device described above may be implemented by a processor. For example, each procedure of processing in the at least one embodiment may be implemented by a processor which operates based on information such as a program and a computer-readable recording medium having stored thereon the information such as a program. For example, functions of respective parts of the processor may be implemented by individual pieces of hardware, or the functions of the respective parts may be implemented by integrated hardware. For example, the processor includes hardware, and the hardware may include at least one of a circuit which processes a digital signal or a circuit which processes an analog signal. For example, the processor may be formed through use of one or both of: one or a plurality of circuit devices mounted on a circuit board; and one or a plurality of circuit elements mounted thereon. An integrated circuit (IC) or the like may be used as the circuit device(s), and a resistor, a capacitor, or the like may be used as the circuit element(s).

The processor may be, for example, a CPU. It should be noted, however, that the processor is not limited to a CPU, and for example, one of various types of processors such as a graphics processing unit (GPU) and a digital signal processor (DSP) may be used as the processor. The processor may also be, for example, a hardware circuit implemented by an application-specific integrated circuit (ASIC). The processor may be formed of, for example, a plurality of CPUs, or may be formed of a hardware circuit implemented by a plurality of ASICs. The processor may also be formed of, for example, a combination of a plurality of CPUs and a hardware circuit implemented by a plurality of ASICs. The processor may also include, for example, one or more of an amplifier circuit which processes an analog signal, a filter circuit, and the like.

In the above, the at least one embodiment of the present disclosure has been described in detail with reference to the drawings, but specific configurations are not limited to those of the at least one embodiment and encompass a change in design and the like without departing from the gist of the present disclosure.

What is claimed is:

1. A print data generation device, comprising:
a print object data acquisition module configured to acquire print object data in which field information that is an object to be printed is expressed in a matrix by a first axis indicating a plurality of records that are objects to be printed and a second axis indicating columns of a plurality of classes of the objects to be printed;
a printing position information acquisition module configured to acquire printing position information in which class information indicating classes of field information that correspond to the columns is associated with position information indicating printing positions that correspond to the classes of the columns;
a generation module configured to generate, based on the printing position information, print data for printing the field information included in the print object data at the printing positions associated with the classes of the field information; and
an output module configured to output the generated print data to a printing apparatus.

2. The print data generation device according to claim 1, wherein the generation module is configured to generate, when the columns of the classes that are included in the printing position information are not included in the print object data, the print data with the printing positions that correspond to the columns of the excluded classes as blank fields in the printing position information.

3. The print data generation device according to claim 1, wherein, in the print object data, a record indicating the class information is placed as a head record.

4. The print data generation device according to claim 1,
wherein the printing position information acquisition module is configured to acquire second printing position information in which column position information indicating positions of the columns that are aligned in a direction of the second axis is associated with position information indicating printing positions of field information that correspond to the columns, and
wherein the generation module is configured to generate the print data based on association by one of the printing position information or the second printing position information.

5. The print data generation device according to claim 4, wherein the generation module is configured to generate the print data by determining, based on contents of a head record included in the print object data, which of the printing position information and the second printing position information is to be used for the association.

6. The print data generation device according to claim 1, wherein the generation module is configured to generate the print data by determining the classes of the columns of the field information to be printed at the printing positions, through one of forward matching or backward matching between the class information of the printing position information and information indicating the classes of the columns that are included in the print object data.

7. The print data generation device according to claim 1, wherein the generation module is configured to generate the print data by determining the classes of the columns of the field information to be printed at the printing positions, through exact matching between the class information of the printing position information and information indicating the classes of the columns that are included in the print object data.

8. A printing system, comprising:
the print data generation device of claim 1; and
a printing apparatus configured to print based on the print data generated by the print data generation device.

9. A print data generation method, comprising:
acquiring print object data in which field information that is an object to be printed is expressed in a matrix by a first axis indicating a plurality of records that are objects to be printed and a second axis indicating columns of a plurality of classes of the objects to be printed;
acquiring printing position information in which class information indicating classes of field information that correspond to the columns is associated with position information indicating printing positions of field information that correspond to the columns;
generating, based on the printing position information, print data for printing the field information included in the print object data at the printing positions associated with the classes of the field information; and
outputting the generated print data to a printing apparatus.

10. A program for causing a computer to:
acquire print object data in which field information that is an object to be printed is expressed in a matrix by a first axis indicating a plurality of records that are objects to be printed and a second axis indicating columns of a plurality of classes of the objects to be printed;
acquire printing position information in which class information indicating classes of field information that correspond to the columns is associated with position information indicating printing positions of field information that correspond to the columns;
generate, based on the printing position information, print data for printing the field information included in the print object data at the printing positions associated with the classes of the field information; and
output the generated print data to a printing apparatus.
